(19) United States
(12) Patent Application Publication
(10) Pub. No.: US 2016/0377475 A1
(43) Pub. Date: Dec. 29, 2016

(54) WEIGHT LOSS FLOOR MAT

(71) Applicant: SAMUEL WILLIAM CLARY, WILMINGTON, NC (US)

(72) Inventor: SAMUEL WILLIAM CLARY, WILMINGTON, NC (US)

(21) Appl. No.: 15/193,009

(22) Filed: Jun. 25, 2016

Related U.S. Application Data
(60) Provisional application No. 62/184,279, filed on Jun. 25, 2015.

(51) Int. Cl. G01G 19/52; G01G 23/36; H04W 88/04

(52) U.S. Cl. CPC G01G 19/52; H04W 88/04; G01G 23/36

(57) ABSTRACT

A floor mat configured to encourage weight loss through the use of a timer, an alarm, and/or one or more weighing devices. The device is specifically designed to look like an ordinary floor mat in appearance, size and texture and will include a processor that can receive a signal from the user and in response the processor can activate a timer and/or an alarm. The processor can be configured to receive a signal from a weighing mechanism included within the device. The device can be equipped with a transmitter configured to receive information from the processor and to transmit that information to a display that is not physical attached to the device or to another device such as a cellular phone or a computer. The device can feature means to input data into the processor—such as a touch screen keypad incorporated into an LCD display.

### CROSS-REFERENCE TO RELATED APPLICATIONS

This Application claims the benefit of priority to U.S. Provisional Application No. 62/184,279 filed on Jun. 25, 2015. The content of U.S. Provisional Application No. 62/184,279 filed on Jun. 25, 2015 is incorporated by reference in its entirety.

### BACKGROUND OF THE INVENTION

(a) Field of the Invention

The present invention is in the technical field of weight loss devices, weight measuring devices and floor coverings.

(b) Background Art

There is no shortage of weight loss devices on the market today. As a group, Americans are increasingly overweight and unhealthy despite being inundated with information about weight loss. For example, research has shown that people that weigh themselves regularly are more likely to lose weight than those that do not. However, the inconvenience associated with doing so oftentimes results in overweight people not taking the time to weigh themselves regularly.

A scale is a weight measuring device commonly found in American homes that is commonly kept in the bathroom—hence the name “bathroom scale.” Scales are typically stored in the bathroom or some other location in the home where they will be out of the way when people are walking through the area. Some bathroom scales are small enough to fit under a counter or on a shelf and others are simply too large to easily store so they are typically located close to a wall or other area where people are less likely to find them to be in the way when they are not in use. Because of their size, namely their height, and their close proximity to the floor, scales can represent a significant trip and fall hazard around the home. This is particularly true for those that are elderly, infirm or otherwise restricted in their mobility.

Moreover, a number of individuals have a difficult time using the standard bathroom scale including the disabled and some morbidly obese or very large individuals have difficulty standing on and reading the readout of the typical bathroom scale.

Despite the inconvenience of storing a bathroom scale, they are still the most common and easiest way for an individual to monitor his weight. Few people store and eat their meals in the same place that they store their scales largely because it is not convenient to store a scale in a high traffic area such as a kitchen nor is it practical or all that common to store or consume one's meals in the bathroom or other location that is generally considered convenient for eating. Having a scale in the kitchen or other high traffic area is particularly useful to those that need to monitor their weight on a regular basis for weight loss or medical reasons. However, storing the scale in the kitchen generally creates either storage or safety issues as discussed previously.

One solution to these problems that has been arrived at by more than one inventor is to store the readout separately from the scale and/or to store the scale in the floor beneath a floor tile. For example, in U.S. Pat. No. 6,781,167 issued to Montagnino et al. described a scale that is meant to be mounted into flooring and covered with tile or other flooring materials. Montagnino et al. describes a scale that transmits weight information to a readout located near the scale but off of the floor. Similarly, Nobes et al. in U.S. Pat. No. 6,864,436 describes a scale whose frame can be connected to floor tile. The scale described by Nobes et al. is capable of wirelessly transmitting data received from the weight sensor(s) in the scale to display the data to a user on a device that is not located on or in the floor. However, while these devices are designed to eliminate the trip and fall hazards that the typical bathroom scale presents, they make moving the device difficult or impossible without creating another hole in the floor and reinstalling the device somewhere else.

Another solution to this set of problems was presented by Brian Kim in U.S. Pat. No. 7,138,586. The Kim reference describes a refrigerator with a retractable scale integrated into the bottom of it such that the scale can be extended away from the refrigerator when in use. However, the scale is as difficult to relocate to another location in the home as the refrigerator would be. In addition, while the scale is in its extended position, it still represents a trip and fall hazard. Moreover, the Kim device is no more suitable for larger, elderly, disabled or otherwise infirm individuals than any other floor scale would be, possible more so since there will always be a large appliance located immediately in front of the device.

Another generally recognized weight loss axiom is that the human brain takes about 20 minutes to process signals from the digestive system indicating enough food has been consumed. As a result, research has shown that dieters that wait 20 minutes between servings consume less calories than those that do not. However in modern society where people are constantly overwhelmed with concerns other than their own health, it is common for people to eat quickly and thus over eat without realizing they have already consumed sufficient food. Even when people are inclined to make the effort, there are so many other things distracting the average consumer these days that their efforts are oftentimes frustrated by other distractions and obligations.

The presently disclosed device was designed to solve the above problems and to be a practical weight loss tool. The device is thin and has a low profile so it is ideal for storage in a high traffic area such as a kitchen and can be used to provide a signal to someone that indicates when they should make a decision as to whether to take another serving of food. The device can be enabled with a micro-processor that can receive information from other components or the user and display information on a display or activate an alarm to notify the user. In addition, the device can provide a convenient means to weigh an individual before and/or after they eat providing another means to deter overeating.

### BRIEF SUMMARY OF THE INVENTION

The present invention is a floor mat configured to encourage weight loss through the use of a timer, an alarm, and/or one or more weighing devices. The device is specifically designed to look like an ordinary floor mat in appearance, size and texture. In a preferred embodiment, the outer covering of the matt is generally a soft resilient material that is typical with floor mats. In addition, the edges of the upper surface of the mat are beveled or slanted to decrease the chances that someone will trip over the device. As a result of this configuration and shape, the device is not only “tip-proof” but it is difficult for someone to catch their foot on the edge of the inventive mat causing them to fall and injure themselves.

In a preferred embodiment, the floor mat is equipped with the means to calculate time and/or activate an alarm. More specifically, a preferred embodiment will include a processor that can receive a signal from the user and in response the processor can activate a timer and/or an alarm. Of course it is possible for the device to be equipped with non-electronic means to start a timer and sound an alarm, but the preferred embodiment will do so with a computer processor designed for this specific purpose. The signal that starts the timer can be provided manually from the user in the form of a button, switch, or other device that sends a signal to the processor. Alternately, the processor can be configured to receive a signal from a weighing mechanism, such as those commonly found in bathroom scales and, in response to receiving the signal, the processor can be configured to start the timer and/or activate the alarm. Similarly, the processor can be configured to sound an alarm after receiving a signal from the timer that a defined interval of time has elapsed. In yet another preferred embodiment, the timer and alarm can be set by the user independently of whether the device contains a weighing mechanism or not.

The device is intended to be used in a high traffic area such as a kitchen. Most household weighing devices are stored in rooms other than the kitchen with the bathroom probably being the most common. In addition, most bathroom scales are stored in a location considered to be out of the way and consequently, oftentimes have to be removed from storage prior to being used. The present device eliminates the need for all of that hassle by providing a device that functions as a kitchen mat, i.e., it is meant to be located in high traffic areas and is thin enough to be unobtrusive—like a typical floor mat.

Optionally, the device can feature one or more weighing mechanisms and/or a display. While the device could feature just one of these features, the preferred embodiment will include both as the functionality of the weighing mechanism is of limited use without a means to display the user's weight. To accommodate larger users or users with mobility issues, there can be more than one weighing mechanism such that a larger user may place one foot on each mechanism. The processor discussed above can be configured to combine the weights from the two weighing mechanisms and to display one weight on the display.

In addition, in a preferred embodiment, the processor is configured to display information on a display or readout that is visible to the user. The processor, upon receiving information from the display, transmits the data to the display or readout such that the user can visually verify their weight. In addition the processor can be configured to display a countdown related to the timer's activity.

Furthermore, the device can be equipped with a transmitter configured to receive information from the processor and to transmit that information to a display that is not physically attached to the device or to another device such as a cellular phone or a computer. The device can feature means to input data into the processor—such as a touch screen keypad incorporated into an LCD display. The user could thereby program the device to activate an alarm to send a signal to another device at pre-defined intervals.

The functionality of the device will be discussed below in more detail with specific reference to the structural components of the inventive mat.

### BRIEF DESCRIPTION OF THE SEVERAL VIEWS OF THE DRAWINGS

FIG. 1 is a top perspective view of a preferred embodiment of the inventive mat;

FIG. 2 is a bottom perspective view of a preferred embodiment of the inventive mat;

FIG. 3 is an exploded view of an embodiment of the inventive mat;

FIG. 4 is an exploded view of a preferred embodiment of the inventive mat;

FIG. 5 is an exploded view of a preferred embodiment of the inventive mat from a different angle.

### DETAILED DESCRIPTION OF THE INVENTION

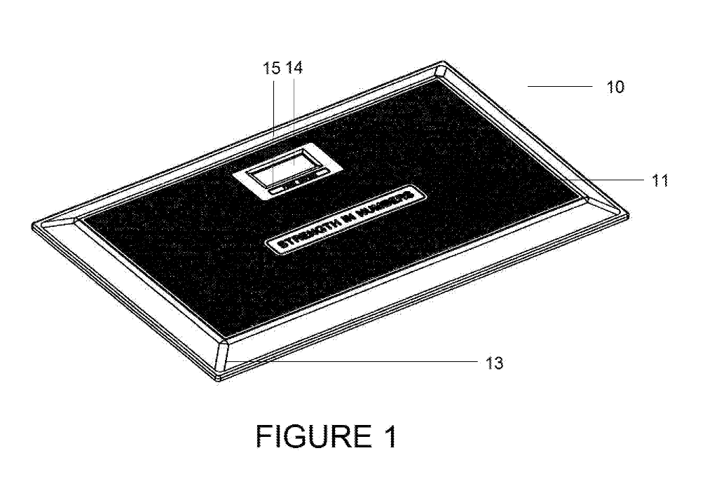

Referring now to the invention in more detail, in FIG. 1 there is shown a top perspective view of a preferred embodiment of the disclosed mat. FIG. 1 shows the upper surface 11 of the mat 10. The edges 13 of the mat 10 have a slanted or beveled surface making the edges 13 of the mat 10 more difficult to trip over. In addition, FIG. 1 shows the display 14 located on the upper surface 11 of the mat. FIG. 1 also shows activation means 15, generally a button, panel or switch that can be depressed by the user to start the timer (not shown).

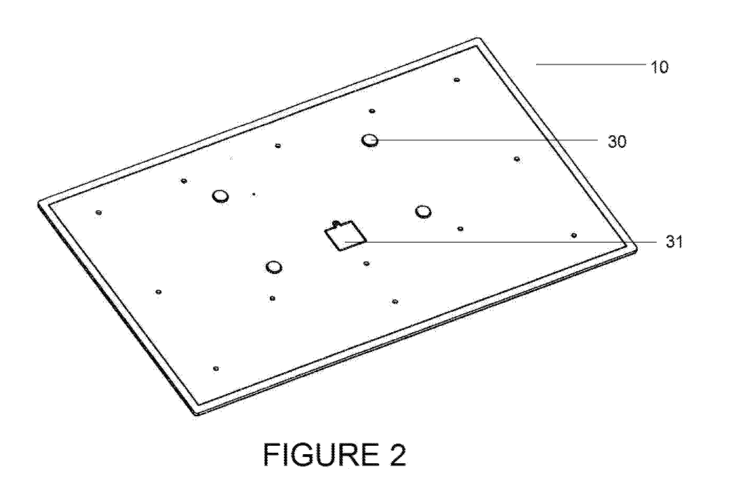

FIG. 2 shows the bottom of an embodiment of the mat. The bottom surface 12 of this embodiment will have one or more feet 30 that are generally located below and act to support the weight sensors (not shown) and support the mat 10 when placed on a solid surface. The feet 30 generally prevent the mat 10 from sliding along a solid surface when force is applied obliquely to the mat 10. FIG. 2 also shows a battery compartment 31 that can be used to house a power source (not shown) for the device. Other embodiments may include a separate power source, a power source that is connected in some way to the mat or no power source at all. However, it is anticipated in the best mode of this device, there will be a power source located within the device to power the processor, display, weighing mechanism, etc. In the best mode contemplated by the inventor the power source consists of one or more batteries.

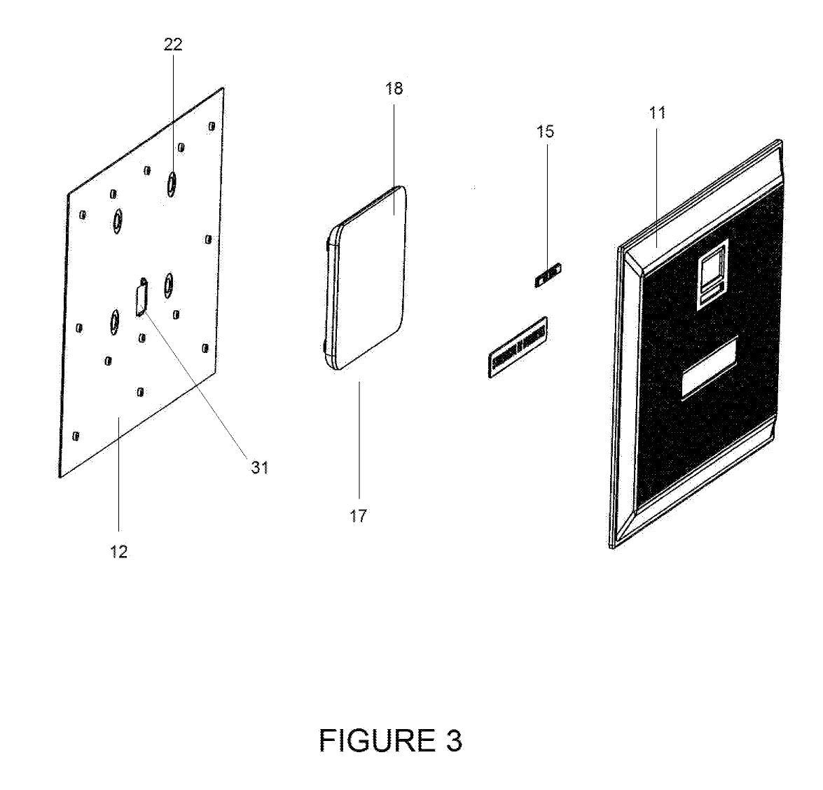

More details of the inner workings of one of the embodiments are shown in FIG. 3. FIG. 3 is an exploded view of an embodiment of the mat with a single weighing mechanism, generally 17, comprising a single weigh plate 18 with a plurality of weight sensors (not shown). The upper surface 11 of the mat 10 and the bottom surface 12 of the mat 10 house the components of the system, namely, the weighing mechanism 17, the processor (not shown), and the alarm (also not shown). The bottom surface 12 of the mat 10 has openings 22 through which the feet (not shown) of the weighing mechanism 17 protrude. In addition, FIG. 3 shows the activation means (a manual switch or button) 15 whereby the user can send a signal to the processor (not shown) or to the timer (also not shown).

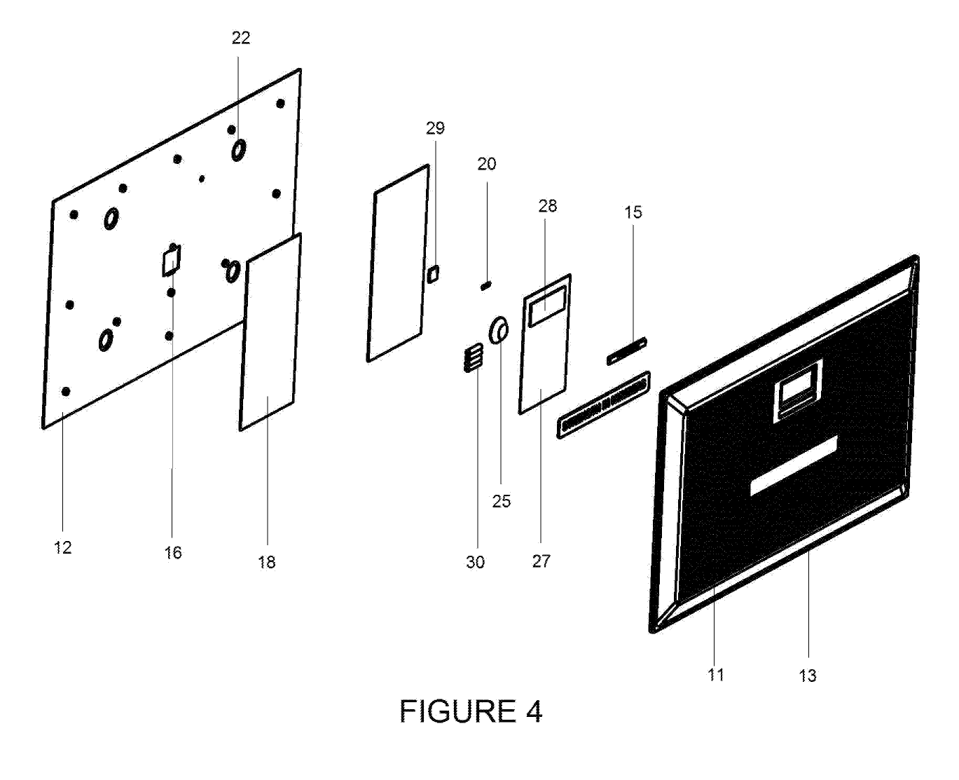

FIG. 4 shows another embodiment of the mat with two weighing mechanisms 17 represented by two weigh plates 18 each with two or more weight sensors (not shown) on the under surface of each weigh plate 18. In further detail, FIG. 4 shows the upper surface 11 of the mat 10 and the lower surface 12 of the mat 10 that house the various components of the device. FIG. 4 also shows the activation means 15 the user uses to send a signal to the processor 20 to start or stop timing a defined interval of time or to activate or deactivate an alarm. In the preferred embodiment, the timer is incorporated into the processor 20 and/or the processor 20 is capable of receiving a signal from the activation means 15 measuring a defined interval of time, such as 20 minutes, and then activating the alarm. FIG. 4 also shows a speaker 25 that in this embodiment serves as an alarm. Other embodiments may use a different form of alarm including a visual alarm that is displayed to the user or a motor that causes the device to vibrate when the prescribed time has elapsed. FIG. 4 also shows a circuit board 27 with an LCD display 28. The circuit board 27 and LCD display 28 receive information directly from the processor 20 or indirectly from a wireless transmitter 29.

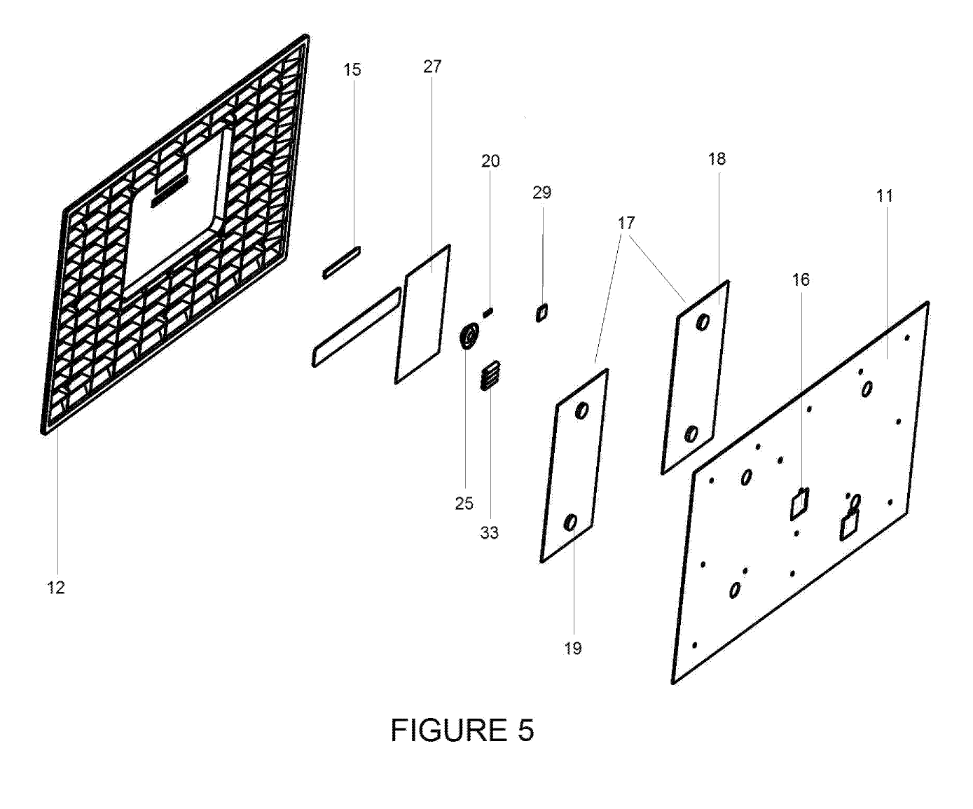

FIG. 5 is an exploded view of the same embodiment shown in FIG. 4, this time showing the opposing sides of each of the components of the device. FIG. 5 shows the same embodiment of the mat with two weighing mechanisms 17 represented by two weigh plates 18 each with two weight sensors 19 on the under surface of each weigh plate 18. In further detail, FIG. 5 shows the upper surface 11 of the mat 10 and the lower surface 12 of the mat 10 that house the various components of the device. FIG. 5 also shows the activation means or button 15 used to send a signal to the processor 20 to start or stop timing a defined interval of time and/or to activate or deactivate an alarm. In the preferred embodiment, the timer is incorporated into the processor 20 and/or the processor 20 is capable of receiving a signal from the activation means 15 and starting a countdown. FIG. 5 also shows a speaker 25 that in this embodiment serves as at least part of an alarm. Other embodiments may use a different form of alarm including a visual alarm that is displayed to the user or a motor that causes the device to vibrate when the prescribed time has elapsed. FIG. 4 also shows a circuit board 27 with an LCD display 28. The circuit board and LCD display receive information directly from the processor 20 or indirectly from a wireless transmitter 29.

While the mat can be used in any room in the home and weather resistant versions can be made for outdoor use, the best mode of this invention known to the inventor would be intended for use in the kitchen. As previously discussed the mat is designed to function as an everyday floor mat that could be placed in front of the kitchen sink, the stove, refrigerator or other appliance. The low profile, below 1.25 inches, and the beveled edges make the mat safe for storage on the floor of the kitchen. Storing the mat in the kitchen makes it accessible when an user is eating and or making eating decisions.

The mat has a number of novel functions. For example, the processor can be configured to receive input from the weighing mechanism, or more specifically, in the best mode, from the weight sensors directly. In response the processor can be programmed to display information, such as the individual's weight, on an LCD display either embedded in the device or located near the device. In the latter case the mat will include a transmitter that can transmit data to another processor, perhaps in an external device. In addition, the processor can be programmed, either through an embedded keypad or an external device in electronic communication with the mat's processor through its wireless transmitter. In the best mode, the processor can be programmed by a user or third party to activate an alarm at preset intervals to remind the user to weigh themselves. This feature can be particularly useful for patients whose weight needs to be measured throughout the day, for example to monitor water retention. The processor can also be equipped with an information storage device such as a hard drive that would allow the processor to store historical data regarding weight history.

The same alarm can be used to alert a user that has just weighed themselves or otherwise provided input to the processor that a defined interval of time interval has elapsed. Thus an user could provide input to the device after finishing a serving of food and the device could measure a defined interval of time and then activate an alarm signaling to the user that they have waited long enough to feel full before deciding to continue eating.

The alarm can be a physical structure embedded within the device or within an external display such as a speaker that produces an auditory signal, a motor that produces vibration, or one more lights to produce a visual signal, or any combination thereof. In the best mode comprehended by the inventor, the signal is an electronic signal sent via a wireless transmitter to an external device such as a cellular phone thereby allowing the device to send a signal to a user regardless of whether they are in visual or auditory range of the mat.

Similarly, the timer can be a physical structure embedded within the device, but in the best mode contemplated by the inventor, the processor can be programmed to measure a discrete interval of time and activate the alarm.

The processor can be any computer microprocessor capable of being programmed to send and receive information to and from other devices including cellular telephones, tablets, computers and other electronic devices. Similarly, the transmitter can be any transmitter that can send and received information and signals to and from the processor in the inventive mat and other processors external to the mat including an RF transmitter or a Bluetooth transmitter. The transmitter is preferably wireless, but need not be.

The advantages of the presently disclosed device are numerous. First and foremost, the device is a weight loss tool that deters individuals from eating a second serving of food. Its very presence in the kitchen serves as a reminder to users that their food choices affect their weight at the time they are making those choices rather than when they are doing something else in another room of the home. Moreover, the device solves the problem of where to store a scale so that it is both accessible when needed, but out of the way when not needed. Since the inventive mat functions as a floor mat and a scale, the scale can be present in the kitchen on the floor without being a trip and fall hazard.

Moreover the device functions as a weight monitoring tool useful for medical professionals and their patients. Some medical conditions requiring consistent monitoring of a patient's weight over relatively short or long intervals of time. The inventive mat provides the means to take such measurements at predetermined intervals, to remind patients of those intervals and to store the data and/or wirelessly transmit the data to an external device operated either by the user or a third party.

Finally, this device is very suitable for those that are challenged in their mobility and/or are otherwise disabled and have difficulty getting around. As discussed above, it can be quite difficult for people with limited mobility, such as those with balance or gait issues and/or people who are morbidly obese to weigh themselves with a normal sized bathroom scale. In the best mode contemplated by the inventor, the mat is approximately 34 inches by 20 inches.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A floor mat comprising a timer, an alarm and means to start and stop the timer and means to activate the alarm.

2. The floor mat of claim 1 wherein the means to start a timer and to activate an alarm comprises a processor programed to measure the passage of a defined interval of time and activate an alarm after the defined interval of time has elapsed.

3. The floor mat of claim 2 further comprising at least one weighing mechanism comprising one or more weight sensors.

4. The floor mat of claim 2 further comprising at least two weighing mechanisms each weighing mechanism comprising one or more weight sensors.

5. The floor mat of claim 3 wherein the processor is also programmed to receive information from the at least one weight sensor, activate the timer in response to receiving the information from the at least one weight sensor, and activate an alarm after a defined interval of time has elapsed.

6. The floor mat of claim 4 wherein the processor is also programmed to receive information from the at least two weight sensors, activate the timer in response to receiving the information from the at least two weight sensors, and activate an alarm after a defined interval of time has elapsed.

7. The floor mat of claim 2 further comprising a wireless transmitter in electronic communication with the processor, the wireless transmitter being configured to electronically send and receive information to and from the processor and another wireless transmitter located outside the mat.

8. The floor mat of claim 3 further comprising a wireless transmitter in electronic communication with the processor, the wireless transmitter being configured to electronically send and receive information to and from the processor and another wireless transmitter located outside the mat.

9. The floor mat of claim 4 further comprising a wireless transmitter in electronic communication with the processor, the wireless transmitter being configured to electronically send and receive information to and from the processor and another wireless transmitter located outside the mat.

10. The floor mat of claim 5 further comprising a wireless transmitter in electronic communication with the processor, the wireless transmitter being configured to electronically send and receive information to and from the processor and another wireless transmitter located outside the mat.

11. The floor mat of claim 6 further comprising a wireless transmitter in electronic communication with the processor, the wireless transmitter being configured to electronically send and receive information to and from the processor and another wireless transmitter located outside the mat.

12. The floor mat of claim 1 wherein the means to start a timer and to activate an alarm comprises a manual button or switch in electronic communication with a timer.

13. The floor mat of claim 12 wherein the timer is in electronic communication with an alarm.

14. The floor mat of claim 1 wherein the means to start a timer and activate an alarm comprises a manual button or switch in electronic communication with a processor programmed to measure the passage of a defined interval of time and to activate an alarm after the defined interval of time has elapsed.
